(19) United States
(12) Patent Application Publication
(10) Pub. No.: US 2009/0171807 A1
(43) Pub. Date: Jul. 2, 2009

(54) SYSTEM AND METHOD FOR INTERACTIVE ELECTRONIC DATA CARD WITH SURVEY AND PURCHASE OPTIONS

(76) Inventor: Sandy Kosloff, Scottsdale, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/343,107

(22) Filed: Dec. 23, 2008

Related U.S. Application Data
(63) Continuation-in-part of application No. 10/794,206, filed on Mar. 5, 2004.
(60) Provisional application No. 61/017,054, filed on Dec. 27, 2007.
(60) Provisional application No. 60/452,294, filed on Mar. 5, 2003.

(51) Int. Cl. G06Q 30/00; G06Q 10/00; G06Q 99/00

(52) U.S. Cl. 705/26; 705/30; 705/1; 235/487

(57) ABSTRACT

An interactive electronic data card and method for enabling a user to communicate information and data to others through a seamless interface that transmits directly into a receiver's communication device of choice and for a receiver to respond to a user's questions and/or surveys.

### CROSS-REFERENCE TO RELATED APPLICATIONS

This application is a non-provisional of and claims priority to U.S. Provisional Application No. 61/017,054 entitled “SYSTEM AND METHOD FOR INTERACTIVE ELECTRONIC DATA CARD WITH SURVEY AND PURCHASE OPTIONS,” filed on Dec. 27, 2007. This application is also a continuation-in-part of and claims priority to U.S. patent application Ser. No. 10/794,206 entitled “METHOD AND APPARATUS FOR PROMOTING INDIVIDUALS AND COMPANIES AND MARKETING THE GOODS AND SERVICES OF OTHERS,” filed on Mar. 5, 2004. The 10/794,206 is a non-provisional of and claims priority to U.S. Provisional Application No. 60/452,294 entitled “METHOD AND APPARATUS FOR PROMOTING INDIVIDUALS AND COMPANIES AND MARKETING THE GOODS AND SERVICES OF OTHERS,” filed on Mar. 5, 2003.

### FIELD OF INVENTION

The present invention relates, generally, to a system and method for interactive electronic data cards, and more particularly to a system and method for enabling a user to communicate information and data to others through a seamless interface that transmits directly into a receiver's communication device of choice and for a receiver to respond to a user's questions and/or surveys. The system and method for interactive electronic data cards also enables a user to transmit information relating to a user's products and/or services so that a receiver can order or purchase the user's products and/or services from any type of communication device including portable communication devices. The system and method for interactive electronic data cards may also include a sticker that directs a receiver to the web based location of the user's interactive electronic data card. The sticker may be applied or fixed to any surface including, but not limited to, the surface of products that are offered by the user.

### BACKGROUND OF THE INVENTION

Business cards printed on paper or cardstock have functioned as a standard way of providing professional contact information, and other information, to others. With the introduction of the internet, programs have been created where users can enter contact information for individuals, businesses, and others that can be stored and accessed by several other users. The contact information that is entered and stored may also be sent to others outside of the originating group that uses the particular program. However, although these types of stored contact information can be easily amended and updated, the information that is submitted and that can be accessed is typically limited to individual names, company names, addresses, telephone numbers, and e-mail addresses.

The ability to send an interactive electronic business card or other type of card to an individual would enable a user to provide more extensive amounts of data and information in an interesting and fun, interactive format. An interactive electronic card would enable a recipient of the card to obtain the exact information they want or need quickly and easily without having to navigate an entire website of a company or a business.

Accordingly, there is a need for an interactive electronic data card that can provide the subject of the data card with an opportunity to put a human face to their business or purpose and thereby leave a more lasting impression on a recipient. An interactive electronic business card that could enable a user to deliver precisely the message they want their potential clients to hear and enable the user to quickly and easily update the information that they want their potential clients to hear. There is also a need for an interactive electronic business or company card that provides an efficient and cost effective way to build a company's corporate brand image along with promoting trust and credibility with customers.

### SUMMARY OF THE INVENTION

The present invention provides a system and method for creating and sharing an interactive electronic data card. The interactive electronic data card is an interactive electronic data card that is capable of being transmitted to a communications device where, once transmitted, it can function as a mini website for the receiver. The receiver can click on various parts of the interactive electronic card to access different types of information relating to the subject of the card.

The method for creating and sharing the interactive electronic data card includes entering information to access a system as a user, inputting data into the system to be communicated to others, converting the data into a readable interactive electronic card, and transmitting the interactive electronic card to a communication tool. The communication tool may include, but is not limited to, a cellular telephone, a PDA, the internet, an intranet, and an electronic e-mail address. A user may also incorporate a link to their interactive electronic data card and incorporate this link into their e-mail signature.

The interactive electronic data card may incorporate many different types of data and/or information including, but not limited to, a user's name and photo, a company name, a title, a phone number, a fax number, a cell phone number, a website address, a mission statement, product information, service information, medical information, employment information, missing person information, voice over capabilities, directions, voice mail, and video clips.

The system for creating and sharing an interactive electronic data card includes a host server, a user interface for accessing the host server and inputting data, a processor for processing the inputted data, a memory for storing the processed data, and display means for displaying the processed data to a receiver in the form of an interactive electronic data card that functions as a mini website. The memory includes at least one database for storing the processed data and may contain multiple databases for storing different categories of processed data. The program application for directing the processing of the inputted data may be stored in the memory. The system may also include an input digitizer coupled or connected to the server for digitizing the data input by the user.

### BRIEF DESCRIPTION OF THE DRAWINGS

The figures illustrate various embodiments of the present invention by way of example, and not by way of limitation. Embodiments of the present invention may include part or all of the features shown in one of these figures, or may include features from two or more figures. Embodiments of the present invention may also include features described in the specification, or elements of features described in the specification. Furthermore, embodiments of the present invention may include features that would be familiar to a person of ordinary skill in the art having studied this document. Thus, a more complete understanding of the present invention may be derived by referring to the detailed description and claims when considered in connection with the drawing figures. Where like reference numbers refer to similar elements throughout the figures, and

FIG. 1 is a block diagram of an exemplary embodiment of a system for providing an interactive electronic data card;

FIG. 2 shows an exemplary embodiment of an interactive electronic data card provided in accordance with the present invention;

FIG. 3 shows a diagram of an exemplary network of interactive electronic data cards in accordance with the present invention;

FIG. 4 is a flowchart showing one exemplary embodiment of an interactive electronic data card system and method in accordance with the present invention;

FIGS. 5-16 show exemplary embodiments of the interactive electronic data card in accordance with the present invention; and

FIG. 17 is an exemplary embodiment of a sticker which may be used in conjunction with the interactive electronic data card in accordance with the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include, but are not limited to, client data, merchant data, product data, personal data, medical data, employment data, service data, etc. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

As used herein, the term “network” shall include any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®, Blackberry®, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers: Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

The system contemplates uses in association with web services, utility computing, pervasive and individualized computing, security and identity solutions, autonomic computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the interactive electronic data card by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the interactive electronic data card. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, card owner, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based and Packet Filtering among others. Firewall may be integrated within a web server or any other CMS components or may further reside as a separate entity.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VB Script or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “user”, “consumer”, “customer”, “cardowner”, “business” or “merchant” may be used interchangeably with each other, and each shall mean any person, entity, machine, hardware, software or business. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same or different geographic locations, or the like. Moreover, the system contemplates the use, sale or distribution of any goods, services or information over any network having similar functionality described herein.

The merchant computer and the bank computer may be interconnected via a second network, referred to as a payment network. The payment network which may be part of certain transactions represents existing proprietary networks that presently accommodate transactions for credit cards, debit cards, and other types of financial banking cards. The payment network is a closed network that is assumed to be secure from eavesdroppers. Exemplary transaction networks may include the American Express®, VisaNet® and the Veriphone® networks.

An “account” or “account number”, as used herein, may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a rewards card, charge card, credit card, debit card, prepaid card, telephone card, embossed card, smart card, magnetic stripe card, bar code card, transponder, radio frequency card or an associated account. The system may include or interface with any of the foregoing cards or devices, or a fob having a transponder and RFID reader in RF communication with the fob. Although the system may include a fob embodiment, the invention is not to be so limited. Indeed, system may include any device having a transponder which is configured to communicate with RFID reader via RF communication. Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc.

The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number “0000 0000 0000 0000”. The first five to seven digits are reserved for processing purposes and identify the issuing bank, card type, etc. In this example, the last (sixteenth) digit is used as a sum check for the sixteen-digit number. The intermediary eight-to-ten digits are used to uniquely identify the customer. A merchant account number may be, for example, any number or alpha-numeric characters that identifies a particular merchant for purposes of card acceptance, account reconciliation, reporting, or the like.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

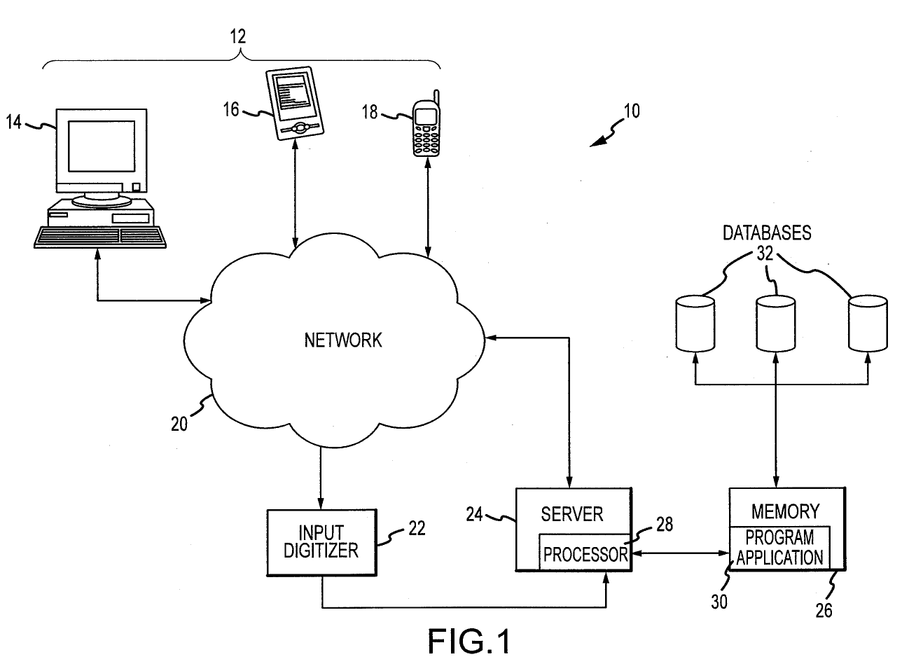

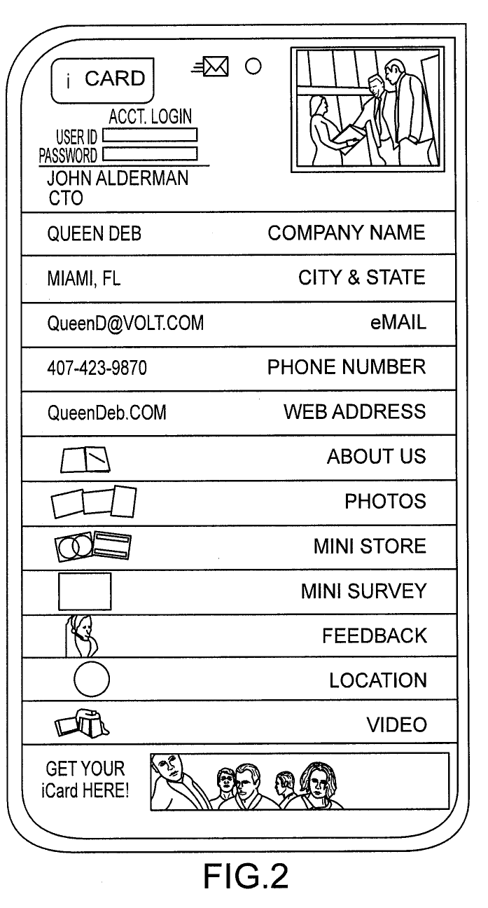

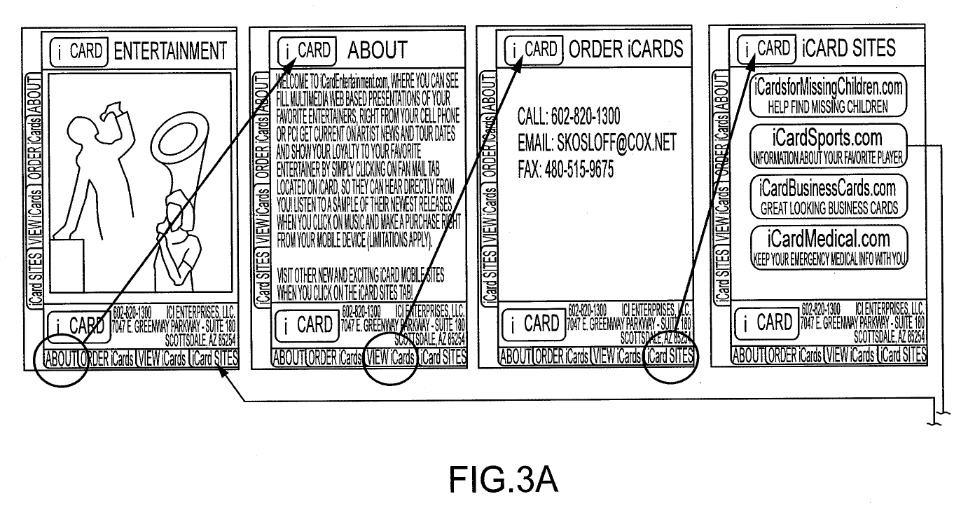

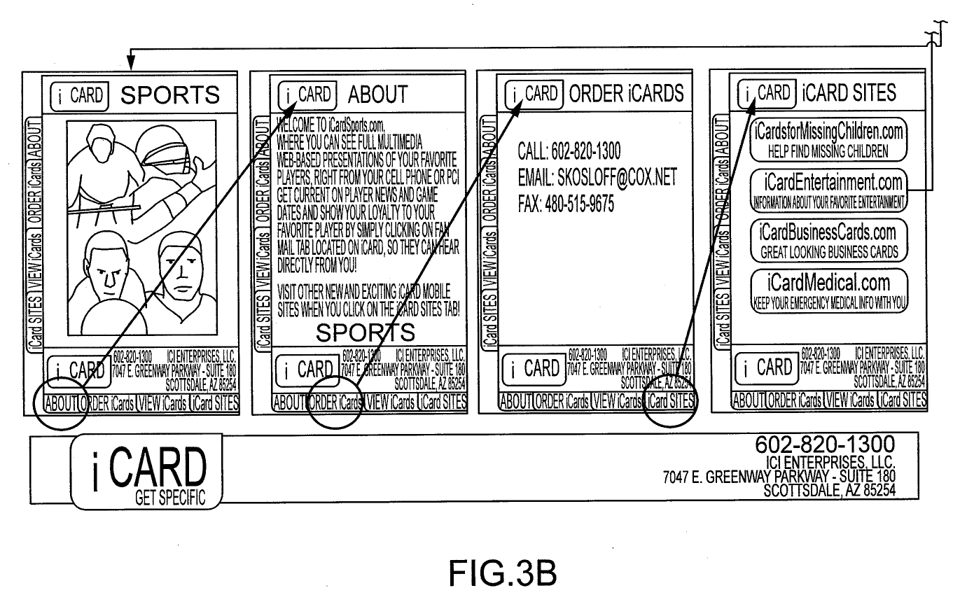

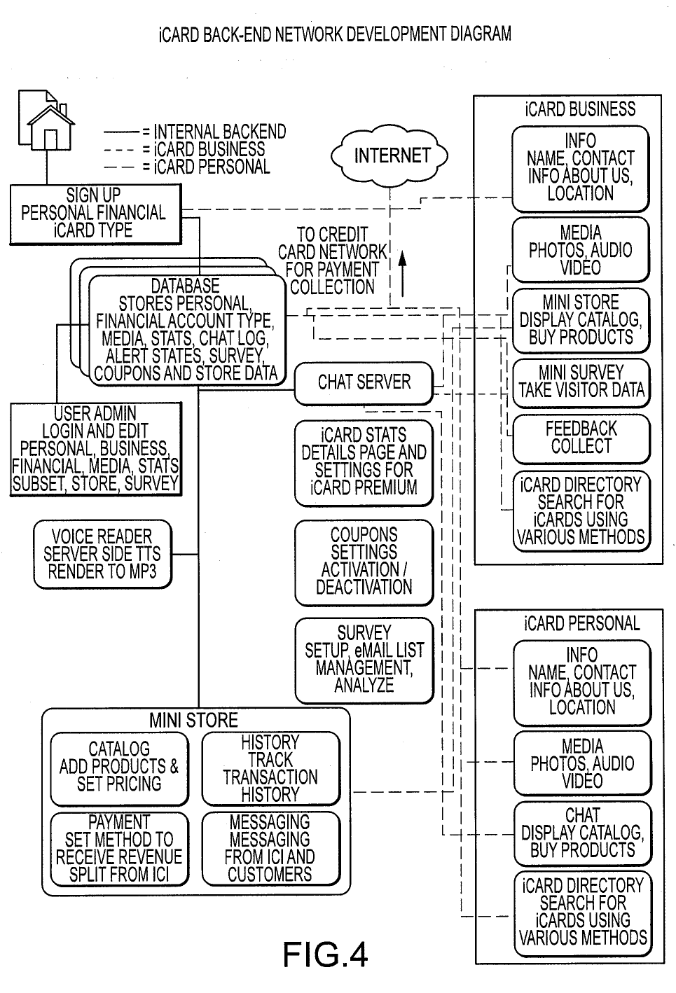

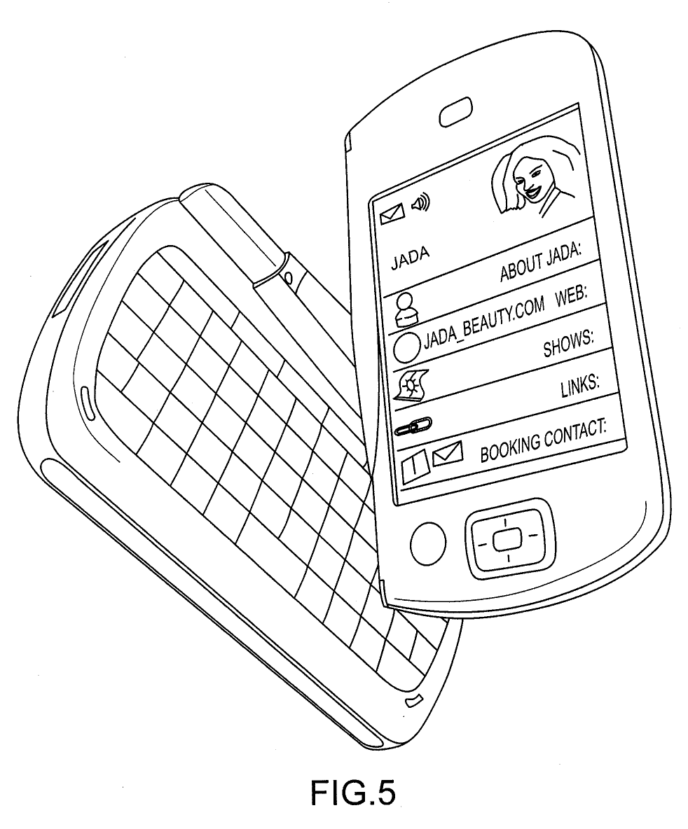

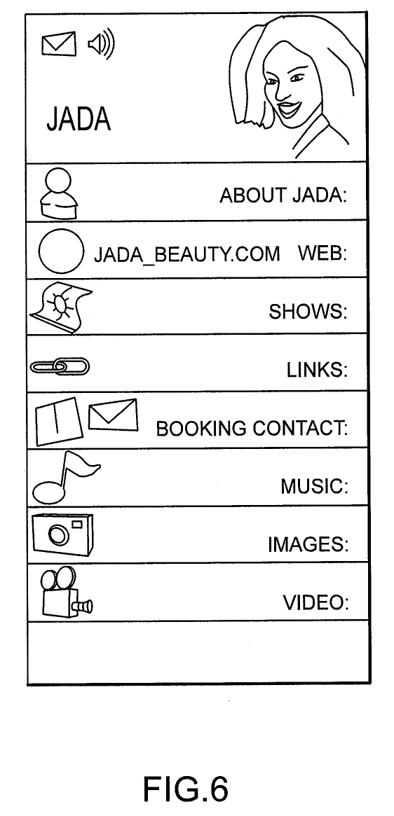

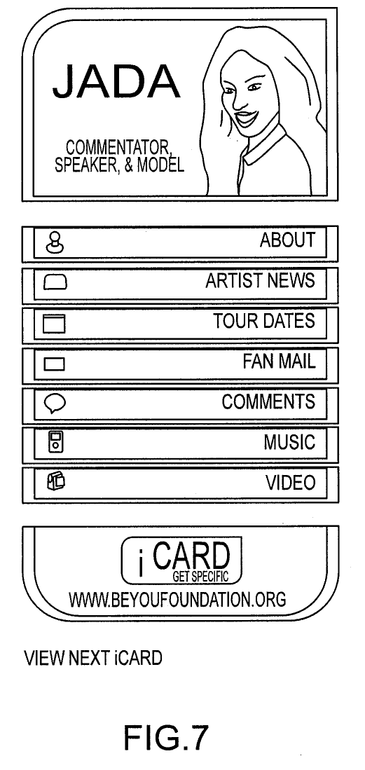

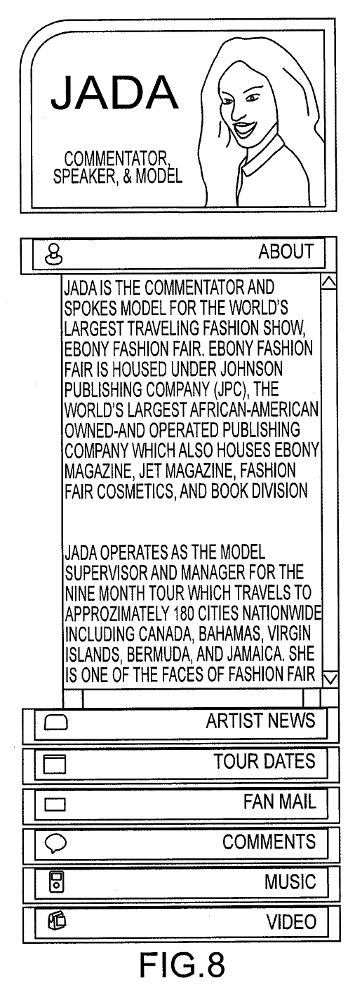

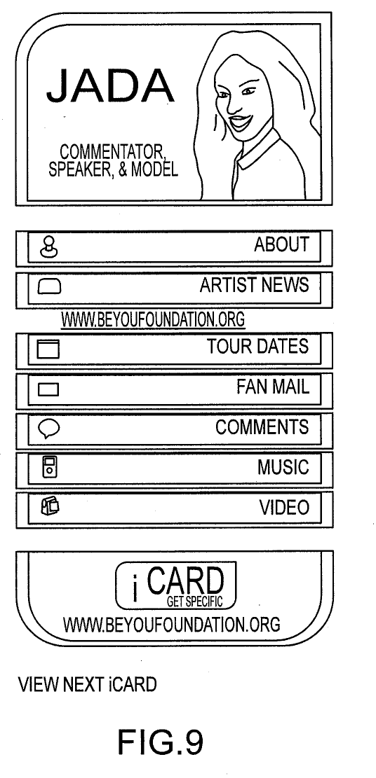

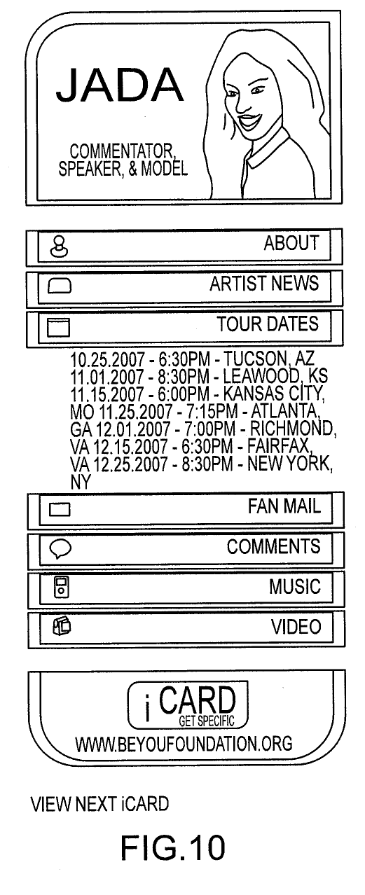

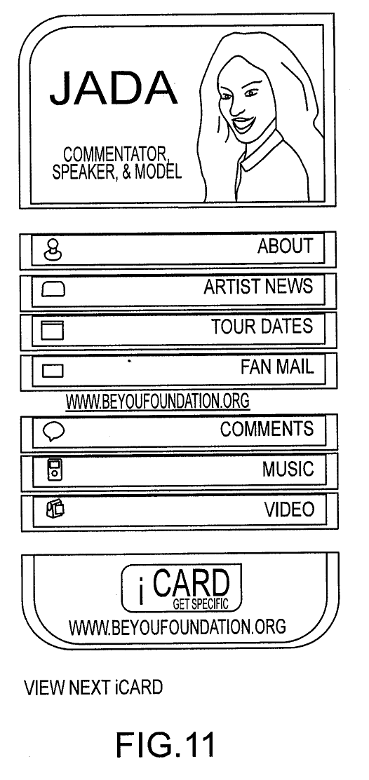

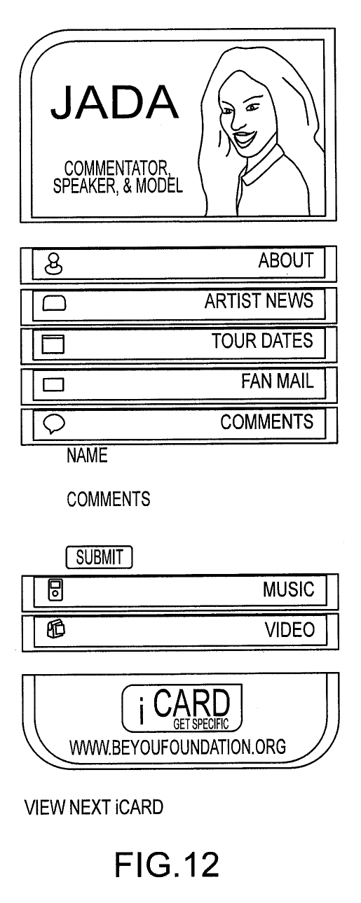

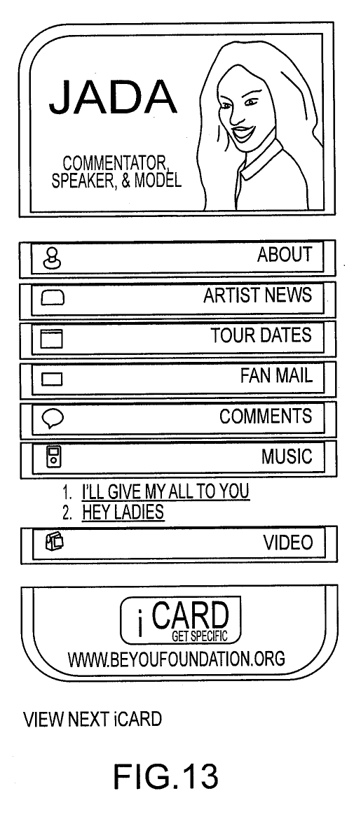

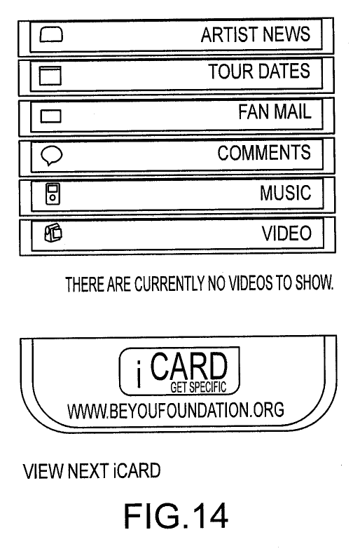

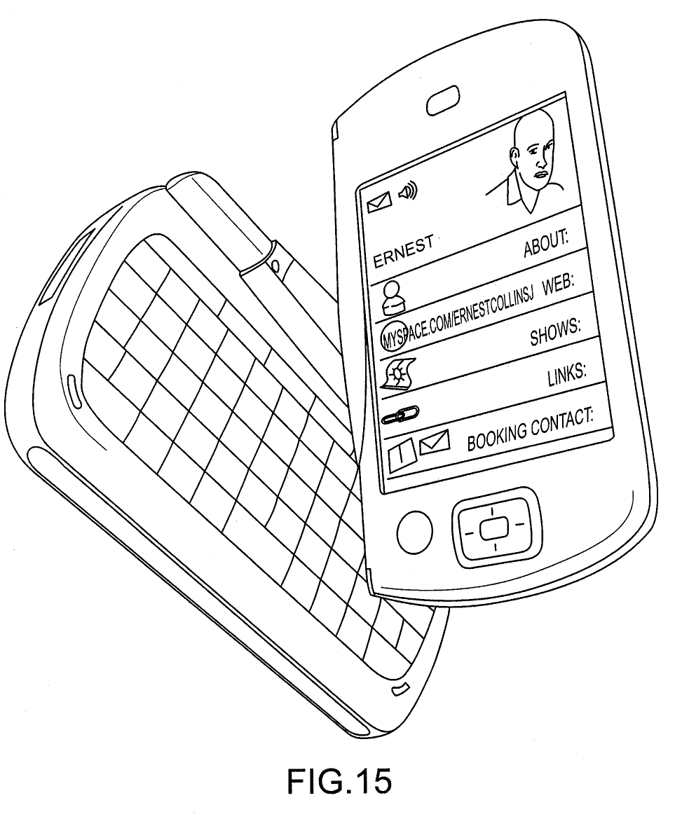

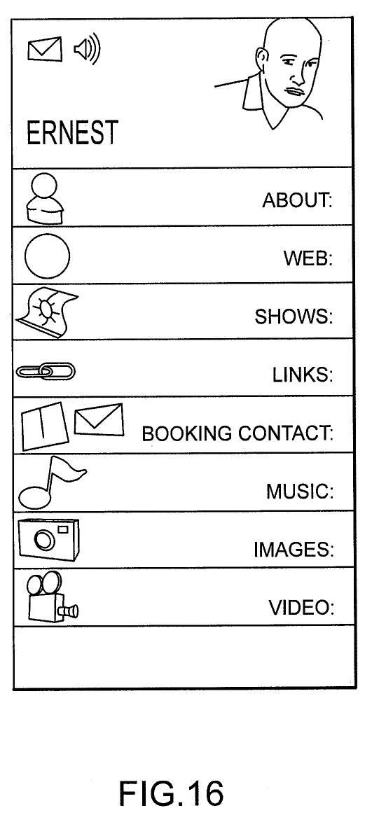

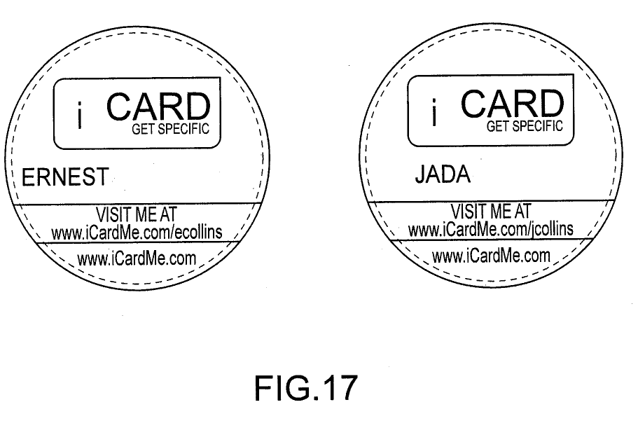

The process flows and screenshots depicted are merely embodiments and are not intended to limit the scope of the invention as described herein. For example, the steps recited in any of the method or process descriptions may be executed in any order and are not limited to the order presented. It will be appreciated that the following description makes appropriate references not only to the steps and user interface elements depicted in the process flows and screenshots, but also to the various system components as described above with reference to FIG. 1.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

Turning now to the Figures, FIG. 1 shows a block diagram of an exemplary embodiment of a system for providing an interactive electronic data card.

### Features

Conversion/connection feature for placement on Icard user's web site for use of Icard systems/software including minimobi and/or miniweb to provide accessibility of information from cellular devices, conversion feature located on individual cards to provide access of different “cellular friendly” patent pending formats, including but not limited to; address, company, title, phone, fax, cell, hyperlink to email, hyperlink to web site, about, photos, map/directions, tunes, audio/slideshow, connect to phone number, sponsor. Storage (personal info). Search directory; locate by name, number, city, state and category. Easy to upload and edit Secured site.

### Use

For access and connection of Icard systems, format and directory from computers and cellular devices. Including but not limited to locating and accessing Icard names, numbers and categories from printed materials, i.e., newspapers and magazines, billboards, retail counters, TV, store-signs, stickers, packaging materials i.e., boxes/wraps, web sites, animal tags, medical tags, promotional products, etc.

### Additional Features

Real time telephone number reports, activity reports.

Storage feature for personal accounts, credit cards, records, Insurance and passports, etc.

Marketing-reports. Clicks, date and time, etc.

Voice Activation and Response

Free Directory and connection

Consumer Report Info

MEDICAL CARD-XRAYS, CARDIO, ALLERGIES, BLOOD TYPE, MEDICATIONS, SURGICAL HISTORY, MEDICAL DEVICES, SPECIAL TESTS; EKG, ECHO, CARDIAC CATHETERIZATION, CHEST RADIO, COLONOSCOPY, CT SCAN, MRI, ULTRASOUND, LAB (scan doc), IMMUNIZATIONS, ADVANCE DIRECTIVES SUCH AS DURABLE POWER OF ATTORNEY, LIVING WILL, ORGAN DONATION, MESSAGE (VIDEO/NARRATION), MED INSURANCE, TRAVEL INSURANCE,

Expand Telephony Backbone with features such as conferencing, video conf, voice/IP, voice recognition, heat sensitive dial pad, message indication, recording, laser transmission of barcode info, automatic pull-up of Icard,

Computer Conversion Solution for cellular devices. Transforms device into a mini computer (mini-mobi) for full keyboard and incorporate features seen on PC's and laptops.

1. A method for creating and sharing an interactive electronic data card to obtain consumer and/or customer preferences comprising the steps of:
entering information to access a system as a user;
inputting data into the system to be communicated to consumers and/or customers wherein said data includes at least one question and a plurality of predesignated responses for said at least one question;
converting said data into a readable interactive electronic data card capable of being displayed on a screen of a portable communication device; and
transmitting the interactive electronic data card to the portable communication device thereby enabling the consumers and/or customers to read said at least one question and select at least one of said plurality of predesignated responses from the portable communications device.

2. The method of claim 1 further comprising the step of tabulating the predesignated responses selected by the consumers and/or customers and displaying the tabulated responses on the interactive data card.

3. The method of claim 2 wherein the tabulated responses are displayed on the interactive electronic data card in real time.

4. The method of claim 1 wherein said step of inputting data further comprises inputting product and/or service information and the step of converting said data further comprises creating a merchant account capability where the consumers and/or customers can purchase said products and/or services from the portable communication device.

5. The method of claim 4 further comprising the step of tabulating the products and/or services purchased by the consumers and/or customers and enabling access to the tabulated products and/or services.

6. The method of claim 5 further comprising the step of displaying the tabulated products and/or services on the interactive electronic data card.

7. The method of claim 6 wherein the step of displaying the tabulated products and/or services comprises the step of displaying the tabulated products and/or services in real time.

8. A system for creating and sharing an interactive electronic data card to obtain consumer and/or customer preferences comprising:
a host server;
a user interface for accessing the host server and inputting at least one question and a plurality of predesignated responses for said at least one question;
a processor for processing said at least one question and the plurality of predesignated responses and converting said at least one question and the plurality of responses into a readable interactive electronic data card capable of being displayed on a screen of a portable electronic communication device;
a memory for storing the at least one processed and converted question and the processed and converted plurality of predesignated responses; and
at least one portable electronic communications device having a screen for displaying the processed and converted question and the processed and converted plurality of predesignated responses in the form of an interactive electronic data card thereby enabling a consumer and/or customer to read said at least one question and select at least one of said plurality of predesignated response from the at least one portable communications device.

9. The system of claim 8 wherein the user interface further includes the capability of accessing the host server and inputting product and/or service information and the processor further includes the capability of processing the product and/or service information and creating a merchant account capability where the consumers and/or customers can purchase said products and/or services from the portable communication device.

10. The system of claim 9 wherein the memory includes multiple databases for storing the processed and converted questions and predesignated responses, the processed product and/or service information, and the purchased products and/or services.
